(19) United States
(12) Patent Application Publication
(10) Pub. No.: US 2024/0214731 A1
(43) Pub. Date: Jun. 27, 2024

(54) SOMATOSENSORY VIBRATOR FOR A WEARABLE DEVICE

(71) Applicant: Acrox Technology Corporation LTD., Taipei (TW)

(72) Inventor: James Chen, Taipei (TW)

(73) Assignee: Acrox Technology Corporation LTD., Taipei (TW)

(21) Appl. No.: 18/391,881

(22) Filed: Dec. 21, 2023

(30) Foreign Application Priority Data
Dec. 22, 2022 (TW) 111149558

(51) Int. Cl. H04R 3/08; G06F 3/16; G08B 6/00; G10L 19/16; H02J 7/00; H04R 1/02; H04R 1/28

(52) U.S. Cl. CPC H04R 3/08; G06F 3/162; G08B 6/00; G10L 19/173; H02J 7/0042; H04R 1/028; H04R 1/2811; H04R 2420/07

(57) ABSTRACT

A somatosensory vibrator for a wearable device is disclosed. The wearable device includes a wearable element, and the somatosensory vibrator includes a body, a speaker unit, and a communication device. The body has a coupling portion configured to couple with the wearing element. The speaker unit is arranged to the body. The communication device is electrically connected to the speaker unit, and configured to cause the speaker unit to generate a vibration in response to a first signal.

### CROSS REFERENCE TO RELATED APPLICATION

This application claims the benefit of Taiwan's Patent Application No. 111149558, filed on Dec. 22, 2022, at Taiwan's Intellectual Property Office, the disclosures of which are incorporated herein in their entirety by reference.

### TECHNICAL FIELD

The present disclosure is related to a somatosensory vibrator for a wearable device, and more particularly to a somatosensory vibrator for a wearable device regarding the acoustic sound.

### BACKGROUND

In recent years, electronic equipment has become an important factor in people's lives. People like to engage with audio and video in an immersive way. Therefore, the resolution of electronic devices for displaying images is constantly being improved, and the acoustic sound quality of electronic devices is becoming more and more realistic.

In the equipment used for electronic game, a vibration function for the joystick that increases the sense of presence has been introduced. For example, when operating the joystick to play the game, if encountering obstacles, being hit, or encountering explosions, etc., the joystick will vibrate to simulate the real feeling that the body is experiencing. However, the components that make the joystick vibrate are all motors. The motor uses its rotation to indirectly generate vibrations. This kind of vibration does not feel strong enough on the human body. Also, earphones are commonly used in the audio electronic equipment of the e-game competition. If you want to play e-games while listening to the sound and feeling the vibration of the sound at the same time, you need an electronic device with sounds and intense vibrations.

### SUMMARY OF INVENTION

In view of the above-mentioned drawbacks in the prior art, the present invention proposes a somatosensory vibrator for a wearable device, which is configured with a speaker unit rather than an electrical motor. In one embodiment, the speaker unit has a diaphragm, a coil or a voice coil that is powered to form an electromagnet, and permanent magnets, etc. After the coil is energized, it can generate suction or thrust on the diaphragm with the permanent magnet, causing the diaphragm to vibrate vertically so that when the wearable device is attached to the user, the vertical vibration of the somatosensory vibrator can make the user feel a strong sense of presence of vibration. The speaker unit is electrically connected to the communication device. The communication device includes a transceiver, a decoder, and a low-pass filter, and can receive the wireless signal with sound from the mobile device. The wireless signal is then converted into an analog signal by the decoder, and the analog signal can be outputted to the earphone and low-pass filter at the same time. After the analog signal passes through the low-pass filter, the low-pass filter outputs a low-frequency sound signal to drive the speaker unit to vibrate.

In one embodiment, the speaker unit is completely disposed in a casing, and is completely covered by the casing. For example, the diaphragm of the speaker unit is not exposed outside. In another embodiment, the speaker unit is partly disposed in a casing. For example, the diaphragm of the speaker unit is exposed outside, but other parts of the speaker unit, such as coils or voice coils, permanent magnets, etc., are disposed in the casing.

In accordance with one aspect of the present disclosure, a somatosensory vibrator for a wearable device is disclosed. The somatosensory vibrator communicates with an electronic device, wherein the wearable device includes a wearable element, and the somatosensory vibrator includes a casing, a resonant speaker and a circuit board. The casing has a join part configured to be combined with the wearing element. The resonant speaker is fixed to the casing. The circuit board supplies power to the resonant speaker, and includes a communication device, which is disposed on the circuit board, electrically connected to the resonant speaker, and configured to drive the resonant speaker in response to a first signal from the electronic device so that the resonant speaker resonates with the casing.

In accordance with another aspect of the present disclosure, a somatosensory vibrator for a wearable device is disclosed, wherein the wearable device includes a wearable element, and the somatosensory vibrator includes a casing, a resonant speaker and a communication device. The casing has a join part to be combined with the wearing element. The resonant speaker is fixed to the casing. The communication device is electrically connected to the resonant speaker, and configured to drive the resonant speaker in response to a first signal so that the resonant speaker resonates with the casing.

In accordance with a further aspect of the present disclosure, a somatosensory vibrator for a wearable device is disclosed, wherein the wearable device includes a wearable element, and the somatosensory vibrator includes a body, a speaker unit, and a communication device. The body has a coupling portion configured to couple with the wearing element. The speaker unit is arranged to the body. The communication device is electrically connected to the speaker unit, and configured to cause the speaker unit to generate a vibration in response to a first signal.

The above embodiments and advantages of the present disclosure will become more readily apparent to those ordinarily skilled in the art after reviewing the following detailed descriptions and accompanying drawings:

### BRIEF DESCRIPTION OF THE DRAWINGS

FIG. 1 shows a schematic diagram of a somatosensory vibrator used in a wearable device according to a preferred embodiment of the present disclosure;

FIG. 2 shows a schematic diagram of the electrical connection between the communication device and the power supply according to a preferred embodiment of the present disclosure;

FIG. 3 shows a schematic diagram of a somatosensory vibrator used in a wearable device according to another preferred embodiment of the present disclosure;

FIG. 4 shows a schematic diagram of a wireless bridging device according to a preferred embodiment of the present disclosure; and

FIG. 5 shows a schematic diagram of a somatosensory vibrator used in a wearable device according to another preferred embodiment of the present disclosure.

### DETAILED DESCRIPTION OF THE PREFERRED EMBODIMENTS

Please read the following detailed description with reference to the accompanying drawings of the present disclosure. The accompanying drawings of the present disclosure are used as examples to introduce various embodiments of the present disclosure and to understand how to implement the present disclosure. The embodiments of the present disclosure provide sufficient content for those skilled in the art to implement the embodiments of the present disclosure, or implement embodiments derived from the content of the present disclosure. It should be noted that these embodiments are not mutually exclusive from each other, and some embodiments can be appropriately combined with another one or more embodiments to form new embodiments; that is, the implementation of the present disclosure is not limited to the examples disclosed below. In addition, for the sake of brevity and clarity, relevant details are not excessively disclosed in each embodiment, and even if specific details are disclosed, examples are used only to make readers understand. The present invention will now be described more specifically with reference to the following embodiments. It is to be noted that the following descriptions of the preferred embodiments of this invention are presented herein for the purposes of illustration and description only; they are not intended to be exhaustive or to be limited to the precise form disclosed.

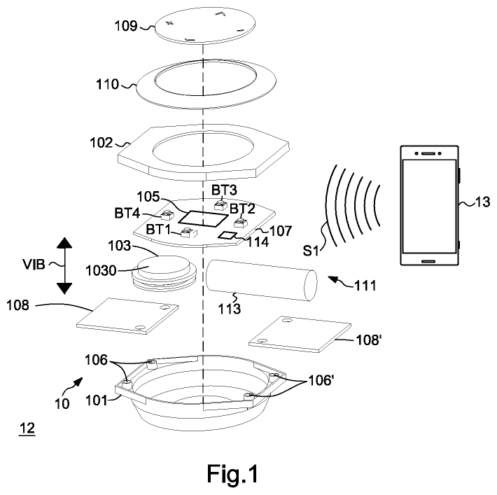

Please refer to FIG. 1, which is a schematic diagram of a somatosensory vibrator 10 for a wearable device 12 according to a preferred embodiment of the present disclosure. The somatosensory vibrator 10 communicates with an electronic device 13, wherein the wearable device 12 includes a wearable element 108, 108′, and the somatosensory vibrator 10 includes a casing 101, 102, a resonant speaker 103, and a circuit board 104. The casing 101 has a join part 106, 106′ configured to be combined with the wearing element 108, 108′. The resonant speaker 103 is fixed to the casing 101, 102. The circuit board 104 supplies power to the resonant speaker 103, and includes a communication device 105, which is disposed on the circuit board 104, electrically connected to the resonant speaker 103, and configured to drive the resonant speaker 103 in response to a first signal S1 from the electronic device 13 so that the resonant speaker 103 resonates with the casing 101, 102.

In any embodiment of the present disclosure, the wearing device 12 has a wearing element 108, 108′, which is used to fasten the casing 101, 102 so that the somatosensory vibrator 10 is fixed and attached to a user. The wearing element 108, 108′ can be, for example, a strap or an elastic and stretchable fixture. The somatosensory vibrator 10 further includes an annular cover 110 and a button plate 109. The user can press the button plate 109 to press the buttons BT1, BT2, BT3, BT4 on the circuit board 104 to control the power on/off, mode switch, or volume operation. The casings 101 and 102 can be combined through the joint parts 106, 106′. The annular cover 110, the button plate 109, the circuit board 104, the resonant speaker 103, and the wearing elements 108, 108′ can be assembled at the same time to cause the casing 101, 102 to cover the circuit board 104 and the resonant speaker 103, cause the annular cover 110 and the button plate 109 to be disposed inside the casing 102, and cause the wearing elements 108, 108′ to be disposed at two sides of the casing 101, 102.

In any embodiment of the present disclosure, after the somatosensory vibrator 10 is assembled, the casing 101, 102 has an internal resonant cavity, and a resonance phenomenon of the casing 101, 102 depends on a material of the casing 101, 102. In response to the resonance phenomenon, the vibrating speaker 103 produces at least one of a specific vibration amplitude, a specific acoustic effect, and a specific sound quality characteristic through the resonant cavity. The casing 101, 102 includes a first casing part 101 having a first shape, and a second casing part 102 having a second shape, wherein the first shape and the second shape collaboratively satisfy one of the following conditions: the first shape conforms to the resonant speaker 103, and the second shape conforms to the circuit board 104; and one of the first shape and the second shape is configured to correspond to a shape of a stack of the resonant speaker 103 and the circuit board 104. It should be noted that, in an embodiment, the casing 101, 102 may not have any low-frequency reflection openings. In addition, the resonant speaker 103 may not depend on the resonance phenomenon of a resonant cavity to make sound, but only depends on the resonance with the casing 101, 102. Different materials of the casing can produce different types of sound.

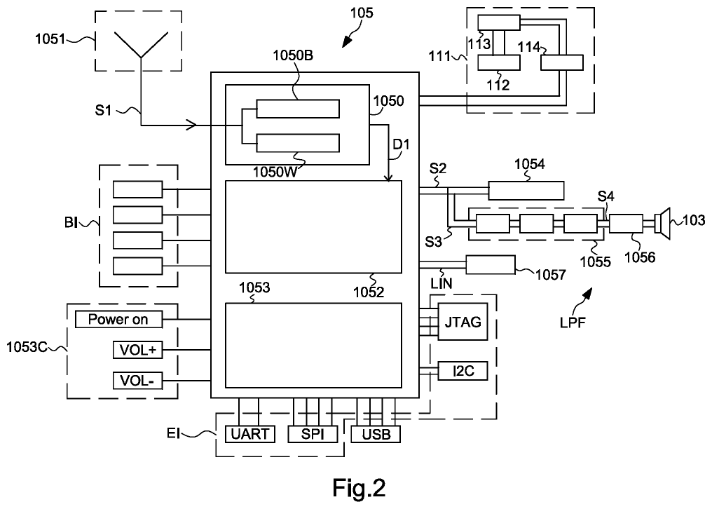

Please refer to FIG. 2, which is a schematic diagram of the electrical connection between the communication device 105 and the power supply 111 according to a preferred embodiment of the present disclosure. Please refer to FIG. 1 and FIG. 2 together. The circuit board 104 includes a power supply 111 configured to supply power to the resonant speaker 103. The power supply 111 includes a charging unit 112, a battery 113, and a power management system 114. The battery 113 is electrically connected to the charging unit 112, and configured to be charged by the charging unit 112. For example, the battery can be a rechargeable lithium battery. The power management system 114 is electrically connected to the battery 113 and the communication device 105, and configured to receive a power output from the battery 113 to power the communication device 105. The communication device 105 includes one of an antenna and a passive amplifier 1051, a communication module 1050, an audio transcoder 1052, and an interface 1053. The antenna or the passive amplifier 1051 receives the first signal S1. The communication module 1050 is configured to demodulate the first signal S1 into an audio code D1, and includes at least one of a blue tooth module 1050B and a wireless network module 1050W. The audio transcoder 1052 is configured to decode the audio code D1. The interface 1053 is electrically connected to a control interface 1053C, a USB interface USB, and a circuit expansion interface EI of the casing 101, 102. The circuit expansion interface EI includes at least one of a debug interface JTAG, a universal asynchronous transceiver transmission interface UART, a serial interface SPI, and a chip interconnection interface I2C. In addition, the interface 1053 can further include a bus interface BI, which can be electrically connected to a high-speed or low-speed bus chip (not shown). The control interface 1053 includes a power switch interface Power on, a volume up interface VOL+, and a volume down interface VOL−, which can correspond to the buttons BT1, BT2, and BT3 respectively.

In any embodiment of the present disclosure, the communication device 105 is configured to convert the first signal S1 into a second signal S2 and a third signal S3. The first signal S1 is a digital signal. The second signal S2 and the third signal S3 both are analog signals. The second signal S2 is received by an earphone 1054. The third signal S3 is filtered by a filter 1055 to output a fourth signal S4. The filter 1055 can be a low-pass filter (LPF). The fourth signal S4 is amplified by an amplifier 1056, and then received by the resonant speaker 103. The fourth signal S4 has a frequency range of 0-200 Hz. The resonant speaker 103 has a diaphragm. The diaphragm has a vibration frequency of 0-200 Hz, and an amplitude related to that of the fourth signal S4. The resonant speaker 103 is a low-frequency resonant speaker capable of emitting a low frequency wave.

In addition to receiving the audio by the wireless modules such as the blue tooth module 1050B and the wireless network module 1050W, the audio can also be received by directly using a wired audio input, such as using the connecting line LIN for audio transmission to connect with the audio playback device 1057.

The somatosensory vibrator disclosed in this disclosure can not only receive audio through wireless transmission, but also convert the audio into vertical vibration of the diaphragm of the resonant speaker or speaker unit, and can also use wired methods to directly receive the audio through a sound source line. In addition to receiving the audio from mobile devices such as mobile phones, the audio can also be received from laptops, personal computers, or devices that lack wireless transmission. In this case, a wireless bridge device can be used to transmit the audio to the somatosensory vibrator.

In addition, in one embodiment, the casing 101 is used as a base, and the casing 102 is used as an upper cover. The resonant speaker 103 and the circuit board 104 can be configured together and fixed in the base first, and then the upper cover is assembled with the base. In another embodiment, the resonant speaker 103 and the circuit board 104 can be respectively configured and fixed in the base and the upper cover, and then the upper cover is assembled with the base, as in the following embodiments.

In one embodiment, the diaphragm 1030 of the resonant speaker 103 is not exposed, and the bottom of the resonant speaker 103 is fixed to the base. In another embodiment, the diaphragm 1030 of the resonant speaker 103 is fixed to the base. In other embodiments, the resonant speaker 103 is fixed to the casing 101, and the casing 101 serves as a base having a bottom opening so that the diaphragm 1030 of the resonant speaker 103 is exposed to the outside, and thus the low-frequency wave can be transmitted out while the resonant speaker 103 is vibrating. In any embodiment of the present disclosure, the diaphragm 1030 of the resonant speaker 103 vibrates in a direction VIB perpendicular to the diaphragm 1030.

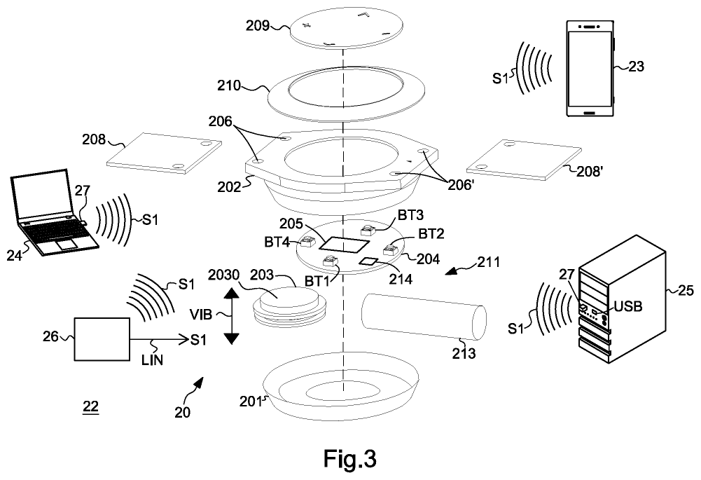

Please refer to FIG. 3, which is a schematic diagram of a somatosensory vibrator 20 for a wearable device 22 according to another preferred embodiment of the present disclosure, wherein the wearable device 22 includes a wearable element 208, 208′, and the somatosensory vibrator 20 includes a casing 201, 202, a resonant speaker 203, and a communication device 205. The casing 202 has a join part 206, 206′ to be combined with the wearing element 208, 208′. The resonant speaker 203 is fixed to the casing 201. The communication device 205 is electrically connected to the resonant speaker 203, and configured to drive the resonant speaker 203 in response to a first signal S1 so that the resonant speaker 203 resonates with the casing 201, 202.

In any embodiment of the present disclosure, the somatosensory vibrator 20 is configured to communicate with an electronic device 23, 24, 25, 26. The electronic device 23, 24, 25, 26 includes at least one of a mobile device 23, a desktop computer 25, a laptop computer 24, and an audio source device 26. The audio source device 26 can send the first signal S1 to the somatosensory vibrator 20 by using the connection line LIN or wireless transmission, and the first signal S1 is received by the communication device 205. The somatosensory vibrator 20 is configured to communicate with a wireless bridge device 27. If the audio source device 26 does not have a wireless transmission device, the wireless bridge device 27 can be used to send the signal S1 to the somatosensory vibrator 20.

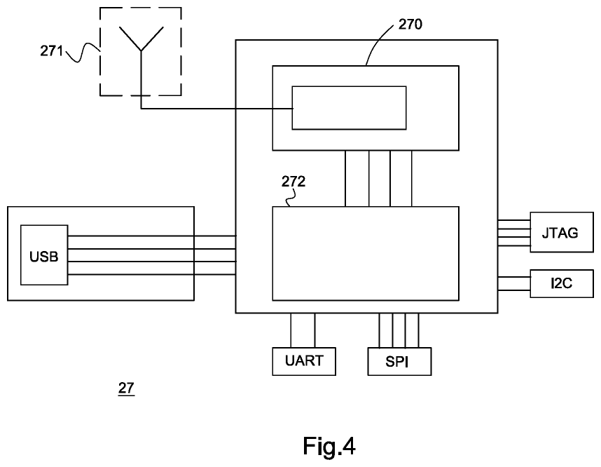

Please refer to FIG. 4, which is a schematic diagram of a wireless bridging device 27 according to a preferred embodiment of the present disclosure. The wireless bridge device 27 has one of an antenna and a passive amplifier 271, a wireless network module 270, and a USB interface USB. The wireless bridge device 27 is connected to an electronic device without a wireless network connection through the USB interface USB, wherein the electronic device without a wireless network connection is connected to the communication device 205 through the wireless bridge device 27 line or an audio line LIN. The interface 272 of the wireless bridge device 27 may include at least one of a USB interface USB, a debug interface JTAG, a universal asynchronous transceiver interface UART, a serial interface SPI, and a chip interconnection interface I2C.

In any embodiment of the present disclosure, the wearing element 208, 208′ of the wearing device 22 is used to fasten the casing 201, 202 so that the somatosensory vibrator 20 is fixed and attached to a user. The casing 201, 202 has an internal resonant cavity, and is configured to generate a resonance phenomenon depending on a material of the casing 201, 202. In response to the resonance phenomenon, the vibrating speaker 203 is configured to produce at least one of a specific vibration amplitude, a specific acoustic effect and a specific sound quality characteristic through the resonant cavity. The casing 201, 202 includes a first casing part 201 having a first shape, and a second casing part 202 having a second shape, wherein the first shape and the second shape collaboratively satisfy one of the following conditions: the first shape conforms to the circuit board 204, and the second shape conforms to the circuit board; and one of the first shape and the second shape is configured to correspond to a shape of a stack of the resonant speaker 203 and the circuit board 204. It should be noted that, in an embodiment, the casing 201, 202 may not have any low-frequency reflection openings. In addition, the resonant speaker 103 may not depend on the resonance phenomenon of a resonant cavity to make sound, but only depends on the resonance with the casing 101, 102. Different materials of the casing can produce different types of sound.

In one embodiment, the casing 201 can be used as a base, and the casing 202 can be used as an upper cover. The casing 201 has an internal thread, and the casing 202 has an external thread. By engaging the internal thread with the external thread, the casing 201 can be screwed into the casing 202 to be fixed. In another embodiment, the casing 201 can be used as a base, the casing 202 can be used as an upper cover, and the casing 201 can be directly engaged with the casing 202.

In any embodiment of the present disclosure, the diaphragm 2030 of the resonant speaker 203 vibrates in a direction VIB perpendicular to the diaphragm 2030. The somatosensory vibrator 20 further includes a power supply 211 configured to supply an electric power to the resonant speaker 203 through the communication device 205. The somatosensory vibrator 20 further includes a circuit board 204 and a power supply 211, and the communication device 205 is disposed on the circuit board 204. The power supply 211 includes a charging unit 112, a battery 113, and a power management system 114. The battery 113 is electrically connected to the charging unit 112, and configured to be charged by the charging unit 112. For example, the battery can be a rechargeable lithium battery. The power management system 114 is electrically connected to the battery 113 and the communication device 205, and configured to receive a power output from the battery 113 to power the communication device 205. The communication device 205 includes one of an antenna and a passive amplifier 1051, a communication module 1050, an audio transcoder 1052, and an interface 1053. The antenna or the passive amplifier 1051 is configured to receive the first signal S1. The communication module 1050 is configured to demodulate the first signal S1 into an audio code D1, and includes at least one of a blue tooth module 1050B and a wireless network module 1050W. The audio transcoder 1052 is configured to decode the audio code D1. The interface 1053 is electrically connected to a control interface 1053C, a USB interface USB, and a circuit expansion interface EI of the casing 201, 202. The circuit expansion interface EI includes at least one of a debug interface JTAG, a universal asynchronous transceiver transmission interface UART, a serial interface SPI, and a chip interconnection interface I2C. In addition, the interface 1053 can further include a bus interface BI, which can be electrically connected to a high-speed or low-speed bus chip (not shown). The control interface 1053 includes a power switch interface Power on, a volume up interface VOL+, and a volume down interface VOL−, which can correspond to the buttons BT1, BT2, and BT3 respectively.

In any embodiment of the present disclosure, the communication device 205 is configured to convert the first signal S1 into a second signal S2 and a third signal S3. The first signal S1 is a digital signal. The second signal S2 and the third signal S3 are analog signals. The second signal S2 is received by an earphone 1054. The third signal S3 is filtered by a filter 1055 to output a fourth signal S4. The filter 1055 can be a low-pass filter LPF. The fourth signal S4 is amplified by an amplifier 1056, and then received by the resonant speaker 103. The fourth signal S4 has a frequency range of 0-200 Hz. The resonant speaker 103 has a diaphragm. The diaphragm has a vibration frequency of 0-200 Hz, and an amplitude related to that of the fourth signal S4. The resonant speaker 103 is a low-frequency resonant speaker capable of emitting a low frequency wave.

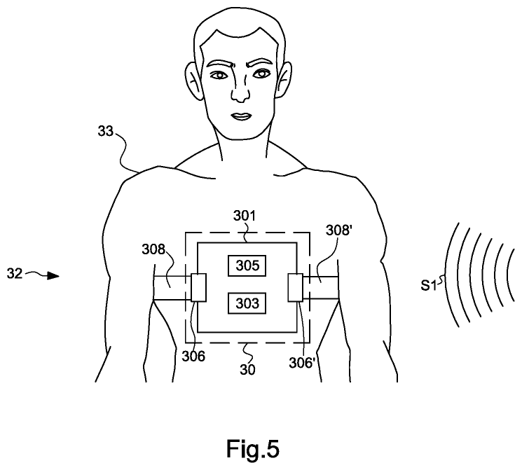

Please refer to FIG. 5, which is a schematic diagram of a somatosensory vibrator 30 for a wearable device 32 according to another preferred embodiment of the present disclosure, wherein the wearable device 32 includes a wearable element 308, 308′, and the somatosensory vibrator 30 includes a body 301, a speaker unit 303, and a communication device 305. The body 301 has a coupling portion 306, 306′ configured to couple with the wearing element 308, 308′. The speaker unit 303 is arranged to the body 301. The communication device 305 is electrically connected to the speaker unit 303, and configured to cause the speaker unit 303 to generate a vibration in response to a first signal S1.

In any embodiment of the present disclosure, the body 301 is a casing 101, the speaker unit 303 is a resonant speaker 103, the resonant speaker 103 is configured to be fixed in the casing 101, 102, and the communication device 305 is configured to drive the resonant speaker 103 in response to the first signal S1 so that the resonant speaker 103 resonates with the casing 101, 102. The wearing device 32 has a wearing element 308, 308′, which is used to fasten the body 301 so that the somatosensory vibrator 30 is fixed and attached to a user 33. The wearing element 308, 308′ can be, for example, a strap or an elastic and stretchable fixture. The somatosensory vibrator 30 further includes an annular cover 110 and a button plate 109. The user 33 can press the button plate 109 to press the buttons BT1, BT2, BT3, BT4 on the circuit board 104 to control the power on/off, mode switch, or volume operation. The casings 101 and 102 can be combined through the joints 106, 106′. The annular cover 110, the button plate 109, the circuit board 104, the resonant speaker 103, and the wearing elements 308, 308′ can be assembled at the same time to cause the casing 101, 102 to cover the circuit board 104 and the resonant speaker 303, cause the annular cover 110 and the button plate 109 to be disposed inside the casing 102, and cause the wearing elements 308, 308′ to be disposed at two sides of the casing 101, 102.

In any embodiment of the present disclosure, after the somatosensory vibrator 30 is assembled, the casing 101, 102 has an internal resonant cavity, and a resonance phenomenon of the casing 101, 102 depends on a material of the casing 101, 102. In response to the resonance phenomenon, the vibrating speaker 103 is configured to produce at least one of a specific vibration amplitude, a specific acoustic effect, and a specific sound quality characteristic through the resonant cavity. The casing 101, 102 includes a first casing part 101 having a first shape, and a second casing part 102 having a second shape, wherein the first shape and the second shape collaboratively satisfy one of the following conditions: the first shape conforms to the resonant speaker 103, and the second shape conforms to the circuit board 104; and one of the first shape and the second shape corresponds to a shape of a stack of the resonant speaker 103 and the circuit board 104. It should be noted that, in an embodiment, the casing 101, 102 may not have any low-frequency reflection openings. In addition, the resonant speaker 103 may not depend on the resonance phenomenon of a resonant cavity to make sound, but only depends on the resonance with the casing 101, 102. Different materials of the casing can produce different types of sound.

In any embodiment of the present disclosure, the somatosensory vibrator 30 is configured to communicate with an electronic device 23, 24, 25, 26. The electronic device 23, 24, 25, 26 includes at least one of a mobile device 23, a desktop computer 25, a laptop computer 24, and an audio source device 26. The audio source device 26 can send the first signal S1 to the somatosensory vibrator 20 by using the connection line LIN or wireless transmission, and the first signal S1 is received by the communication device 205. The somatosensory vibrator 20 is configured to communicate with a wireless bridge device 27. If the audio source device 26 does not have a wireless transmission device, the wireless bridge device 27 can be used to send the signal S1 to the somatosensory vibrator 20.

In any embodiment of the present disclosure, the somatosensory vibrator 30 further includes a power supply 111 configured to supply power to the resonant speaker 103 through the communication device 105. The somatosensory vibrator 30 further includes a circuit board 104, and the power supply 111 and the communication device 105 are disposed on the circuit board 104. The power supply 111 is configured to supply power to the resonant speaker 103. The power supply 111 includes a charging unit 112, a battery 113, and a power management system 114. The battery 113 is electrically connected to the charging unit 112, and configured to be charged by the charging unit 112. For example, the battery can be a rechargeable lithium battery. The power management system 114 is electrically connected to the battery 113 and the communication device 105, and configured to receive a power output from the battery 113 to power the communication device 105. The communication device 105 includes one of an antenna and a passive amplifier 1051, a communication module 1050, an audio transcoder 1052, and an interface 1053. The antenna or the passive amplifier 1051 receives the first signal S1. The communication module 1050 is configured to demodulate the first signal S1 into an audio code D1, and includes at least one of a blue tooth module 1050B and a wireless network module 1050W. The audio transcoder 1052 is configured to decode the audio code D1. The interface 1053 is electrically connected to a control interface 1053C, a USB interface USB, and a circuit expansion interface EI of the casing 101, 102. The circuit expansion interface EI includes at least one of a debug interface JTAG, a universal asynchronous transceiver transmission interface UART, a serial interface SPI and, a chip interconnection interface I2C. In addition, the interface 1053 can further include a bus interface BI, which can be electrically connected to a high-speed or low-speed bus chip (not shown). The control interface 1053 includes a power switch interface Power on, a volume up interface VOL+, and a volume down interface VOL−, which can correspond to the buttons BT1, BT2, and BT3 respectively.

In any embodiment of the present disclosure, the communication device 305 is configured to convert the first signal S1 into a second signal S2 and a third signal S3. The first signal S1 is a digital signal. The second signal S2 and the third signal S3 are analog signals. The second signal S2 is received by an earphone 1054. The third signal S3 is filtered by a filter 1055 to output a fourth signal S4. The filter 1055 can be a low-pass filter LPF. The fourth signal S4 is amplified by an amplifier 1056, and then received by the resonant speaker 103. The fourth signal S4 has a frequency range of 0-200 Hz. The resonant speaker 103 has a diaphragm. The diaphragm has a vibration frequency of 0-200 Hz, and an amplitude related to that of the fourth signal S4. The resonant speaker 103 is a low-frequency resonant speaker capable of emitting a low frequency wave.

While the invention has been described in terms of what is presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A somatosensory vibrator for a wearable device including a wearing element and configured to communicate with an electronic device, comprising:
a casing having a joint part configured to be combined with the wearing element;
a resonant speaker fixed to the casing; and
a circuit board supplying an electric power to the resonant speaker and including:
a communication device disposed on the circuit board, electrically connected to the resonant speaker, and configured to drive the resonant speaker in response to a first signal from the electronic device, so that the resonant speaker resonates with the casing.

2. The somatosensory vibrator as claimed in claim 1, wherein:
the wearing element is configured to fasten the casing, so as to fix and attach the somatosensory vibrator to a user.

3. The somatosensory vibrator as claimed in claim 1, wherein:
the casing has an internal resonant cavity, and is configured to generate a resonance phenomenon depending on a material of the casing; and
in response to the resonance phenomenon, the resonant speaker produces at least one of a specific vibration amplitude, a specific acoustic effect and a specific sound quality characteristic through the resonant cavity.

4. The somatosensory vibrator as claimed in claim 1, wherein:
the casing includes a first casing part having a first shape and a second casing part having a second shape, the first casing part has the joint part, and the first shape and the second shape collaboratively satisfy one of the following conditions:
the first shape conforms to the resonant speaker and the second shape conforms to the circuit board; and
one of the first shape and the second shape corresponds to a shape of a stack of the resonant speaker and the circuit board.

5. The somatosensory vibrator as claimed in claim 1, wherein:
the circuit board further includes a power supply configured to supply the electric power to the resonant speaker; and
the power supply includes:
a charging unit;
a battery electrically connected to the charging unit and configured to be charged by the charging unit; and
a power management system electrically connected to the battery and the communication device, and configured to receive a power output from the battery to power the communication device.

6. The somatosensory vibrator as claimed in claim 1, wherein:
the communication device includes:
one of an antenna and a passive amplifier configured to receive the first signal;
a communication module configured to demodulate the first signal into an audio code, and including at least one of a blue tooth module and a wireless network module;
an audio transcoder configured to decode the audio code; and
an interface electrically connected to a control interface, a USB interface and a circuit expansion interface of the casing,
wherein the circuit expansion interface includes at least one of a debug interface, a general asynchronous transceiver transmission interface, a serial interface and a chip interconnection interface.

7. The somatosensory vibrator as claimed in claim 1, wherein:
the communication device is configured to convert the first signal into a second signal and a third signal, the first signal is a digital signal, and the second signal and the third signal both are analog signals.

8. The somatosensory vibrator as claimed in claim 7, wherein:
the communication device further includes a filter and an amplifier;
the second signal is received by an earphone; and
the third signal is filtered by the filter to output a fourth signal, and the fourth signal is amplified by the amplifier and then received by the resonant speaker.

9. The somatosensory vibrator claimed in claim 1, wherein:
the resonant speaker is a low frequency resonant speaker capable of emitting a low frequency wave.

10. A somatosensory vibrator for a wearable device including a wearing element, comprising:
a casing having a joint part configured to be combined with the wearing element;
a resonant speaker fixed to the casing; and
a communication device electrically connected to the resonant speaker, and configured to drive the resonant speaker in response to a first signal, so that the resonant speaker resonates with the casing.

11. The somatosensory vibrator claimed in claim 10, wherein:
the somatosensory vibrator is configured to communicate with an electronic device including at least one of a mobile device, a desktop computer, a laptop and an audio source device.

12. The somatosensory vibrator claimed in claim 10, wherein:
the somatosensory vibrator is configured to communicate with a wireless bridge device;
the wireless bridge device has one of an antenna and a passive amplifier, a wireless network module, and a USB interface, wherein:
the wireless bridge device is connected to an electronic device without a wireless network connection through the USB interface, wherein the electronic device without the wireless network connection is connected to the communication device through one of the wireless bridge device and an audio cable.

13. The somatosensory vibrator as claimed in claim 10, wherein:
the wearing element is configured to fasten the casing so as to fix and attach the somatosensory vibrator to a user;
the casing has an internal resonant cavity, and is configured to generate a resonance phenomenon depending on a material of the casing; and
in response to the resonance phenomenon, the resonant speaker is configured to produce at least one of a specific vibration amplitude, a specific acoustic effect and a specific sound quality characteristic through the resonant cavity.

14. The somatosensory vibrator as claimed in claim 10, wherein:
the casing includes a first casing part having a first shape and a second casing part having a second shape, and the first shape and the second shape collaboratively satisfy one of the following conditions:
the first shape conforms to the resonant speaker, and the second shape conforms to the circuit board; and
one of the first shape and the second shape is configured to correspond to a shape of a stack of the resonant speaker and the circuit board.

15. The somatosensory vibrator as claimed in claim 10, wherein:
the somatosensory vibrator further includes:
a power supply configured to supply an electric power to the resonant speaker through the communication device; and
a circuit board mounting thereon the power supply and the communication device;
the power supply includes:
a charging unit;
a battery electrically connected to the charging unit and configured to be charged by the charging unit; and
a power management system electrically connected to the battery and the communication device, and configured to receive a power output from the battery to power the communication device.

16. The somatosensory vibrator as claimed in claim 10, wherein:
the communication device is electrically connected to a power supply; the communication device includes:
one of an antenna and a passive amplifier configured to receive the first signal;
a communication module configured to demodulate the first signal into an audio code, and including at least one of a blue tooth module and a wireless network module;
an audio transcoder configured to decode the audio code; and
an interface electrically connected to one of a control interface, a USB interface and a circuit expansion interface of the casing,
wherein the circuit expansion interface includes at least one of a debug interface, a general asynchronous transceiver transmission interface, a serial interface and a chip interconnection interface;
the communication device is configured to convert the first signal into a second signal and a third signal, the first signal is a digital signal, and the second signal and the third signal both are analog signals;
the communication device further includes a filter and an amplifier;
the second signal is received by an earphone;
the third signal is filtered by the filter to output a fourth signal, and the fourth signal is amplified by the amplifier and then received by the resonant speaker; and
the resonant speaker is a low frequency resonant speaker capable of emitting low frequency wave.

17. A somatosensory vibrator for a wearable device including a wearing element, comprising:
a body having a coupling portion configured to couple with the wearing element;
a speaker unit arranged to the body; and
a communication device electrically connected to the speaker unit, and configured to cause the speaker unit to generate a vibration in response to a first signal.

18. The somatosensory vibrator as claimed in claim 17, wherein:
the body is a casing;
the speaker unit is a resonant speaker;
the resonant speaker is configured to be fixed to the casing;
the communication device is configured to drive the resonant speaker in response to the first signal, so that the resonant speaker resonates with the casing;
the wearing element is configured to fasten the casing so as to fix and attach the somatosensory vibrator to a user;
the casing has an internal resonant cavity, the casing is configured to generate a resonance phenomenon depending on a material of the casing;
in response to the resonance phenomenon, the resonant speaker is configured to produce at least one of a specific vibration amplitude, a specific acoustic effect and a specific sound quality characteristic through the resonant cavity;
the casing includes a first casing part having a first shape and a second casing part having a second shape, and the first shape and the second shape collaboratively satisfy one of the following conditions:
the first shape conforms to the resonant speaker, and the second shape conforms to the circuit board; and
one of the first shape and the second shape corresponds to a shape of a stack of the resonant speaker and the circuit board;
the somatosensory vibrator is configured to communicate with an electronic device, wherein the electronic device includes at least one of a mobile device, a desktop computer, a laptop and an audio source device;
the somatosensory vibrator is configured to communicate with a wireless bridge device;
the wireless bridge device has one of an antenna and a passive amplifier, a wireless network module, and a USB interface; and
the wireless bridge device is connected to the electronic device through the USB interface, wherein the electronic device is connected to the communication device through one of the wireless bridge device and an audio cable.

19. The somatosensory vibrator as claimed in claim 17, wherein:
the somatosensory vibrator further includes:
a power supply configured to supply an electric power to the resonant speaker through the communication device, and
a circuit board mounting thereon the power supply and the communication device;
the power supply includes:
a charging unit;
a battery electrically connected to the charging unit and configured to be charged by the charging unit; and
a power management system electrically connected to the battery and the communication device, and configured to receive a power output from the battery to power the communication device.

20. The somatosensory vibrator as claimed in claim 17, wherein:
the communication device is electrically connected to a power supply, and includes:
one of an antenna and a passive amplifier configured to receive the first signal;
a communication module configured to demodulate the first signal into an audio code, and including at least one of a blue tooth module and a wireless network module;
an audio transcoder configured to decode the audio code; and
an interface electrically connected to one of a control interface, a USB interface and a circuit expansion interface of the casing, wherein the circuit expansion interface includes at least one of a debug interface, a general asynchronous transceiver transmission interface, a serial interface and a chip interconnection interface;
the communication device is configured to convert the first signal into a second signal and a third signal, the first signal is a digital signal, and the second signal and the third signal both are analog signals;
the communication device further includes a filter and an amplifier;
the second signal is received by an earphone;
the third signal is filtered by the filter to output a fourth signal, and the fourth signal is amplified by the amplifier and then received by the resonant speaker; and
the resonant speaker is a low frequency resonant speaker capable of emitting low frequency wave.
